(19) United States
(12) Patent Application Publication
(10) Pub. No.: US 2008/0266112 A1
(43) Pub. Date: Oct. 30, 2008

(54) Valentine Pillow

(75) Inventors: Bartel Marinus van de Sluis, Eindhoven (NL); Martijn Krans, Den Bosch (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/158,429

(22) PCT Filed: Dec. 12, 2006
(86) PCT No.: PCT/IB2006/054759

§ 371 Date: Jun. 20, 2008

(30) Foreign Application Priority Data
Dec. 22, 2005 (EP) 05112814.8

(51) Int. Cl. G08B 23/00; H04N 7/14

(52) U.S. Cl. 340/573.1; 348/14.08; 348/E07.077

(57) ABSTRACT

A communication device (100) includes a tactile sensor (120) configured to receive tactile input including a traced shape, a predefined shape or a constricting pressure, which is classified or characterized as a hug when covering a large area of the tactile sensor, such as forces directed toward each other applied on opposing surfaces of the tactile sensor (120). A controller (110) is configured to categorize the tactile input in accordance with presets, e.g., stored in a memory (130) of the communication device (100). The controller (110) is further configured to output a transmit signal including a characterization of the tactile input in accordance with the presets. A renderer (140) is configured to provide an illuminating pattern associated with the characterization and/or the tactile input, which may be a symbol, icon, word and drawing, where additionally the characterization may be a hug.

The present invention relates to communication of messages including visual and tactile messages related to emotion between two beloved persons through specially designed physical objects such as in the form of pillows.

It is expected that in the future, people will communicate with each other more as communication technology improves further. Communication through various media will get richer. For instance, there will be different levels of communication and presence simulation allowing a user to choose the communication type that is best suited for the situation.

Various solutions related to different types of communication have been proposed. For example WO 98/14860, which is hereby incorporated by reference in its entirety, describes a system for communication of feelings, including a computer, a sensor array for detecting touch by a user and delivery sensor signals, an actuator array for delivering physically perceptible taction signals to a user, and a control unit linking the sensor array and the actuator array to the computer. The control unit converts the sensor signals into the taction signals capable of being processed by the computer, indicating the location of the sensors being touched, and converting the taction signals into control signals for the actuator array to be perceived by the other user.

Similarly, WO 01/41636 A1, which is hereby incorporated by reference in its entirety, introduces a tactile medium to enhance the interactive capabilities of the World Wide Web. This document mentions pressure sensors and tactile output devices, such as motors capable to drive mechanical (e.g. moving liquid gas or air) and other devices (e.g. robotic, vibrating, electromagnetic, temperature changing devices) to provide the tactile output. It gives an example of communication of parents with their three-year-old daughter through the World Wide Web by placing their hands onto pressure sensitive pads, sending the pressure signals to the other remote end. The daughter was able to feel the touch of her parents, while they communicated with each other over the phone.

Another publication, namely, U.S. Patent Application Publication (PAP) 2005/0132290 A1, also entirely incorporated herein by reference, discloses a skin stimulation system integrated into a piece of clothing or any type of wearable accessory, connected to a controlling device. The system comprises a variety of sensing means for input information, and actuators placed on or close to the body of a person wearing this piece of clothing or wearable accessory (such as jewelry), and used for generating visual, audio, tactile, gustatory and/or olfactory stimuli (enabled, for example, by heat, pressure, vibrations, electrical pulses, air nozzles integrated with clothing). It also teaches a method for tuning key parameters (for instance, intensity, duration and/or frequency) of the stimuli, mostly by pivoting actuator parts about an axis to bring them closer or further from the user's body. The proposed system supports the use of the tactile communication channel on the sender and receiver sides, enabling the users to “touch” each other despite being at distinct locations, and combines the benefits of traditional long-distance communication systems (e-mail, SMS, MMS, EMS, etc.) The system includes means for selecting a coded signal based on a user's manual, visual or audio input or signals originating from biometric or environmental sensors.

A method and a communication station for facilitating remote, non-verbal interpersonal communication is described in U.S. PAP 2003/0184498 A1, also incorporated herein by reference in its entirety, which deals with detection of a person's proximity or gesture converted into signals by a first station and further transmitted to a second station producing a visual output (primarily based on a LED display) indicative of proximity and of the gesture input. The deployed sensors are typically analog, and the communication interface is configured to communicate via a real time link, such as the Internet.

In another publication WO 2004/088960 A1, which is incorporated herein by reference in its entirety, sensory output devices (SOD) are disclosed, such as wearable items, three dimensional objects (pebbles, ornaments, toy characters, etc.), including controls responsive to the content of SMS messages, or to the recognition of spoken words or phrases in a telephone conversation to provide a response such as a thermal change, vibrational or other tactile response, color change or olfactory output. The output may be intensified in dependence upon the number of times at which a particular word, phrase or emoticon is identified, the control means learning from identity information to associate a current call with a historic personality trait to maintain or adapt the response provided by the SOD. According to this publication, it is possible to develop an SOD personality based on cumulative responses of the emoticons within the messages it receives. Once the personality has been developed, the SOD could perform its actions on its own without prompting. If the SMS or telephone conversation includes happy messages or hugs, then the SOD, provides hugs through constriction and relaxation of a wearable item, or the phone display could display cheerful characteristics e.g. smiley, glowing lights, including change of color to warm cheerful color.

For improved expression and communication of feeling, a communication device is provided which includes a tactile sensor configured to receive tactile input including a traced shape, a predefined shape or a constricting pressure, which is classified or characterized as a hug when covering a large area of the tactile sensor, such as pressures or forces directed toward each other applied on opposing surfaces of the tactile sensor. A controller is configured to categorize the tactile input in accordance with presets, e.g., stored in a memory of the communication device. The controller is further configured to output a transmit signal including a characterization of the tactile input in accordance with the presets. A renderer, such as a pillow, is configured to provide an illuminating pattern associated with the characterization and/or the tactile or other input, which may be symbol, a word and a drawing, where additionally the characterization may be a hug.

Illustratively, a set of two interactive light pillows, e.g., made for couples living, or are, apart is provided where the pillows are uniquely coupled to each other, in a similar way as a set of ‘walkie-talkies’ (also called two-way radio) and allows two people to express feelings towards each other and stay in touch. Of course, the pillows can also be used by a group of people, or for other communication purposes. The form of pillow is chosen based on the vision that it is more suitable for communication of affection, softness, mildness, and so on, which may take place between two beloved persons. Such communication does not necessarily involve a conversation or an extensive exchange of information. In many cases it is more important to create a feeling of connectedness between people, for instance, between beloved ones.

Further areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

These and other features, aspects, and advantages of the apparatus and methods of the present invention will become better understood from the following description, appended claims, and accompanying drawing where:

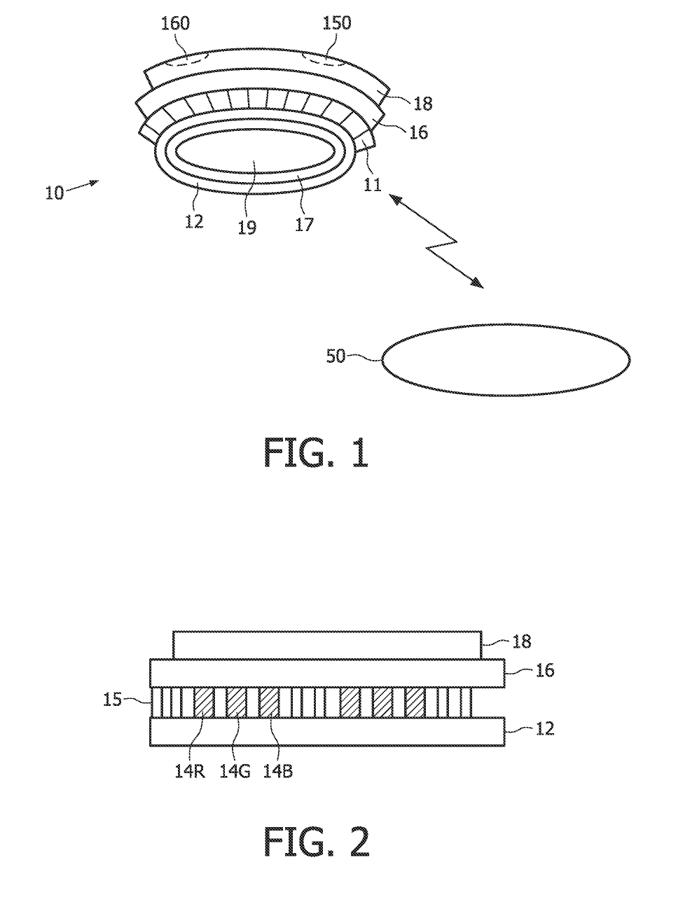

FIG. 1 shows a partial sectional view of a communication device according to one embodiment; and

FIG. 2 shows a sectional view of the upper layers of the communication device; and

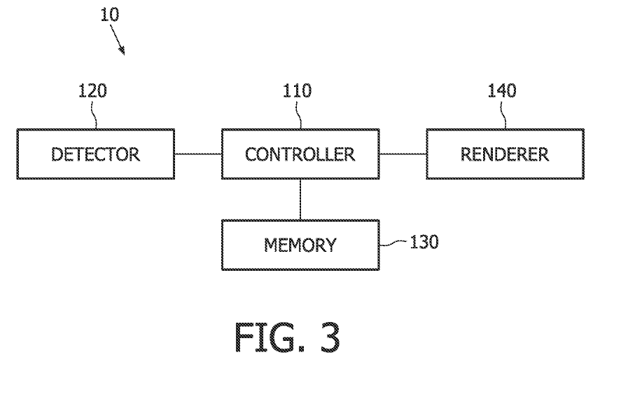

FIG. 3 shows a block diagram of the communication device.

The following description of certain exemplary embodiment(s) is merely exemplary in nature and is in no way intended to limit the invention, its application, or uses.

Mobile telephony and PC-mediated communication through networks such the Internet or wireless telephony network have increased the connectivity of people. To further such connectivity, two pillows in accordance with the present communication system provide unobtrusive communication which is better integrated into people's everyday living environment and easy to use intuitively at a moment notice without much planning, where signals communicated between the pillows may be by any means, such as wirelessly through a telephony network, the Internet or any other network. Further, instead of formal communication associated with telephony or the Internet, the pillows allow the communication of feelings in an instinctive way at the spur of a moment, the creating a sense of presence and connectedness as if it were a remote touch or hug from the beloved one.

Some modern technologies enable implementation of such unobtrusive communication devices in efficient and elegant ways. These include “photonic textile” solutions using a light source with fabric diffusing layer, such as disclosed in patent application Serial No. EP 05104677.9, (Attorney Docket No. 000720), filed May 31, 2005, entitled “Light-Source with Fabric Diffusing Layer”; and patent application Serial No. EP 05107974.7, (Attorney Docket No. 002668), filed Aug. 31, 2005, also entitled “Light-Source with Fabric Diffusing Layer”; as well as disclosed in patent application Serial No. EP 05104703.3, (Attorney Docket No. 000470), filed May 31, 2005, entitled “A Fully Textile Electrode Lay-Out Allowing Passive and Active Matrix Addressing,” which are each incorporated herein by reference its entirety.

As disclosed in these patent applications, the pillows according to the present communication system include a light source comprising at least one lighting unit being arranged on a substrate and a diffusing element being arranged to receive and diffuse light emitted by at least one lighting unit, wherein the diffusing element includes at least one layer of non-woven fabric, and optionally may include at least one layer of whitish woven or knitted fabric to give the device a traditional fabric feel.

Illustratively, such lighting units in the light-source may comprise an array of light emitting diodes (LEDs), which are attractive and have high efficiency and low power consumption. The LED array may be configured to illuminate to form any desired pattern having any desired color and illumination, which may also blink on/off at any desired frequency, uniformly or randomly, for example. Illustratively, each LED of the array is independently addressable, so that different colors and intensity may be provided by each LED thus allowing illumination thereof to form various patterns, including texts or words, icons, symbols, and drawings.

Electrode layouts and circuitry for the LEDs are provided within the fabric, enabling the display of desired patterns or images on the pillow's surface, as disclosed in the above noted patent applications, thus forming passive and/or active matrix addressing. The fabric or textile includes a multi-layer warp formed from interwoven electrically conductive and non-conductive yarns comprising a multi-layer warp comprising electrically conductive and non-conductive yarns; and a weft comprising electrically conductive and non-conductive yarns. Some of the electrically conductive weft yarns cross selected electrically conductive warp yarns without electrical contact therebetween by being separated from the electrically conductive warp yarns by at least one non-conductive warp yarn in each layer of the multi-layer warp. For example, two interwoven electrically conductive yarns transverse to each other are separated by the non-conductive yarn layer, where the two separated electrodes or conducting layers are interconnected as needed through conductive paths through the insulating non-conductive yarn layer.

FIG. 1 shows a pillow 10, such as fluid fillable pillow for example conducive to being squeezed or hugged, having a flexible membrane 17, filled for example with a compressed air body 19 for example, and a substrate 12, which covers and is supported by the membrane 17. Generally, the substrate 12 encloses the fully textile electrode layout, including various circuit elements such as controllers, processors, memories and other electronic circuits populated on a flexible circuit board for example, including circuitry for sensing, signal processing and communication, such as pressure sensors, transceivers, antenna, duplexer, mixers, modulators, demodulators, converters, filters and the like.

As shown in FIG. 3, the controller 110 may be any type of controller or processor, such as those described in U.S. 2003/0057887, that is capable of providing output or control signals in response to input signals from a detector 120 including for example pressure sensors and/or selector buttons, e.g., for selecting modes of operation, executing instruction stored in a memory 130, which may be any type of memory, RAM, ROM, removable memory, CD-ROM, and the like, also as described in U.S. 2003/0057887. It should be understood user detector or sensor 120, the controller 110, memory 130, although shown as being part of the pillow 10, may be integrated units, or separate units alone or in combination with other units.

Returning to FIG. 1, the circuit elements may be incorporated in the substrate 12, or disposed inside the membrane 17, or optionally may be installed in a separate unit and communicate with the pillow 10 through wired or wireless links.

A plurality of sensor-display modules 11 is jointly disposed on the external surface of the substrate 12. Each sensor-display module 11 comprises a sensor 15 of a capacitive proximity type for example, and a pixel of three color LEDs 14R, 14G, 14B for red, green, blue LEDs respectively, shown in FIG. 2. The LEDs 14R, 14G, 14B are connected to and controlled (particularly, addressed) by the controller 110 shown in FIG. 3. The sensor-display modules 11 (FIG. 1) generally provide the detection, for example, (by receiving signals from the sensors 15 (FIG. 2) and further transmitting the signals to the controller 110 shown in FIG. 3) of a finger or special pen drawing a pattern on the pillow. The pattern may be the displayed on the same or the remote pillow 50 (FIG. 1) through lighting up the LED matrix or array formed by the LEDs 14R, 14G, 14B. To achieve an improved illumination quality, the sensor-display modules 11 may be covered by two diffuser layers of non-woven fabric, such as a low-density non-woven fabric layer 16, and a higher-density non-woven fabric layer 18.

The set of pillows provide for improved expression and communication of feeling. In particular, as shown in FIG. 3, a communication device 100 is provided which includes a tactile sensor or detector 120, such as pressure sensors and/or capacitive proximity sensors 15, shown in FIG. 2, configured to receive tactile input including a traced shape, a predefined shape or a constricting pressure, which is classified or characterized as a hug when covering a large area of the tactile sensor, such as pressure forces directed toward each other applied on opposing surfaces of the tactile sensor or pillow 10.

A controller 110 is configured to categorize the tactile input in accordance with presets, e.g., stored in a memory 130 of the communication device 100. The controller 110 is further configured to output a transmit signal including a characterization of the tactile input in accordance with the presets. A renderer 140, such the array of LEDs 14R, 14G, 14B shown in FIG. 2, is configured to provide an illuminating pattern associated with the characterization and/or the traced shape, which may be symbol, a word and a drawing, where additionally the characterization may be a hug. The illuminating pattern may include a contour of the traced shape or a figure representing the traced shape selected from presets stored in the memory.

Illustratively, the renderer is a pillow 10 (FIG. 1) with an array of LEDs having a corresponding counterpart pillow 50, also with such an LED array, remote from the first pillow 10 and for communication therewith. The receiving renderer, e.g., the remote pillow 50, may provide a message displayed via the LED array for example, that the transmitting pillow 10 had transmitted a transmit signal when an acknowledge signal is not received by the transmitting renderer 10 in response to the transmit signal. Alternatively or additionally, or a message is displayed on the remote pillow 50 when no response is received by the user/owner of the remote pillow 50, e.g., with the user is away, so that the user is informed when returns. The LED array or any suitable light sources may be configured to provide the illuminating pattern in varying intensity, color or frequency in dependence on the tactile input and presets for example, which of course may be programmable to change presets or add new ones.

The presets stored in the memory 130 may include predefined shapes selected in response to providing pressure to a predetermined area of the tactile sensor or a selection button 150, which itself may be a particular area of the sensor array and actuated by applying pressure at this particular area. The controller 110 may further be configured to vary the intensity, color or frequency of light emitted from the LED array to be indicative of the type of the tactile input, such as whether a hug, a soft one or a hard one, a particular traced shape, such as a smiley or a heart shape, for example.

It should be noted that any combination of output types may be provided in response to one of a combination of inputs. For example, tracing the shape of a heart along with a hard hug may produce vibrant colors, pulsating faster and faster as the pillow is hugged more and more, or harder and harder. Such output responses may be on both pillows or only on the remote pillow, for example. If no one is available at the remote pillow to receive or respond to the hug, then an indication may be provided on the receiving pillow that a hug was sent by the transmitting pillow. The tactile sensor may also have a further button 160 or a specified area that, when pressed, transmits the transmit signal to activate the remote pillow, for example.

The controller 110 may be configured to transmit the transmit signal in response to a gesture, which may include holding the tactile sensor or pillow near a tagged object, e.g., tagged by an RFID having a unique identification ID and associated data. Any type of wireless radio frequency (RF) short range communication may be used, including infrared, ultrasound, optical or laser communication with nearby devices, such as via short range communication protocols like Bluetooth™ and Zigbee™.

The controller 110 may also be configured to activate a communication link for communication with a person associated with the tagged object. Illustratively, the communication link is a telephone communication link when a telephone and the pillow are brought within close proximity of each other. Further, the communication link may be a videoconferencing link when a display (e.g., of a personal computer, personal digital assistant (PDA), cell phone or the like) and the pillow are brought within close proximity of each other. Thus telephonic or videoconferencing communication is easily provided between the two persons having the pillows. Of course, such communication may be provided with any person, such as by bringing phone close to a picture frame including person A where, for example, the picture frame is tagged and communication is effectuated with person A, telephonic or videoconferencing, as selected in response to bringing the phone (or a display device, e.g. PDA) in close proximity with the picture frame for example which in a communication mode, where telephonic or videoconferencing may be selected or one of them may be the default.

Exemplary Modes of Operation

The pillows may operate in different modes that can allow people to use them in various ways of communication, messaging, and emotional support. For instance, only one person may observe the pillow, when say the sun is shining through the window and the pillow starts lighting up in yellow, and “smiling” (i.e. exhibiting a “smiley” pattern). Thus, the pillow helps brighten up the day of this person. In this case, the pillow may include a light measuring sensor, or may receive signals indicative of the shining sun from an external stand alone light measuring sensor located in the room, for example. Additional examples of “couple-connection” modes are described below.

In an interactive mode, a person can choose from a list of pre-programmed images, or presets stored in the memory 130, using a finger, pointer or special pen, draw a symbol, word, sketch or any pattern on his pillow, and send it to the remote person such as by depressing a particular area or button 160 which may have identifying indicia, such as “send”, for example. The pillow in this case should be able to “sense” the pattern, for instance using integrated pressure sensors or capacitive proximity sensors. The remote pillow on the second end, associated with appropriate software, may detect such pattern, and transform it into a predetermined response, such as lighting up in a particular color or ornament, vibration (e.g. via a vibrator built in the pillow), or just displaying such pattern on an LED-illuminated surface of the remote pillow (and, if desired, on the sender's pillow as well). The displayed pattern (e.g. a heart or smiley image) may be the same as drawn on the sender's pillow, or it can be another predetermined pattern, programmed by the user, or pre-programmed and selected by the user.

Additionally, the remote (as well as the sender's) pillow may also play a predetermined music, wedding song, nature sounds (e.g. the sound of a waterfall, birds, and other animals), olfactory pattern or the like (correspondingly supported by necessary producing devices and circuitry inside or outside the pillow), associated with the particular patterns. A specially configured LED-illuminated surface (a matrix with individually addressable LEDs) of the pillows may display some still pictures or crude video, stored for instance in the memory 130, downloaded by the user, or transmitted from the remote pillow or any other source, for example.

In a more simple embodiment, the user would be able to simply select one from a pre-defined set of say 20 so-called ‘emoticons’ (such as a smiley, heart, blink, tear etc). For instance, by pressing a simple selection button (or a next and previous buttons), a user could go through a list of emoticons and select one. The “send” command could be implemented with the send-button 160 integrated in the pillow, a particular gesture with the pillow or by holding the pillow to a tagged object, e.g., a tagged photo frame containing a picture of the remote beloved one, or a Near Field Communication (i.e. NFC-enabled) mobile telephone.

In a hug mode, on the moment that person A hugs his pillow, the pillow of person B starts glowing and lights up in any desired/programmable way (color, intensity, image or lighting sequence pattern, etc.) which indicates the intensity and type of hug, including a picture or indicia of the sender A. Of course, a picture or indicia of recipient B may be displayed on the sender's pillow at any desired time, such as via selection or in response to transmission of a message to person B, and/or in response to receiving a message from person B, for example.

When person B ‘hugs back’, this act may be indicated by the pillow of person A. If person B does not ‘hug back’ (e.g., because she is absent or has not noticed it), the pillow of person B indicates that there has been a remote hug received from person A. Note that one or both pillows in this case have a “hug” sensor. Again, integrated pressure sensors or capacitive sensors may be used for this purpose. Combining an actuator array, similar to the one described in WO 98/14860, with such pillows, shaped in a suitable manner, can make it huggable, similar to cuddly toys, capable and conducive to hugging.

Mode Selection

The modes (interactive mode, hug mode, etc.) may be selected automatically by the pillow based on the “sensed” input (e.g., an algorithm may distinguish writing from hugging), or may be selected by the user explicitly (e.g., by some form of a user input device such as integrated buttons or a mode selector switch).

Network Communication

For communication, the pillows can make use of a mobile telecommunication network or the Internet. For instance, the pillow may use wireless (e.g., via Bluetooth™) communication with the owner's mobile telephone or computer for accessing some network, such as the cellular network or the Internet. Some mobile telephony providers already create special incentives for partners both using the same provider (so called “family plans”), e.g., enabling them to call each other at a low rate or even for free. One could imagine that for this kind of subscriptions for couples, the Valentine pillows can be an interesting addition. The free-form message drawings could be transferred in the form of an MMS picture format, whereas a pre-defined standard emoticon could be also be communicated using a simple code, enabling it to be sent in a cheaper way (e.g. in SMS format). In general the communication with a mobile telephone is interesting because this enables the presentation of the “message” on the mobile phone display. Furthermore, it also allows leaving a message on the mobile phone for people who are away.

It is known that people want to be able to seamlessly switch from one communication level or medium to another. Thus if a pillow indicates to the owner that the remote lover is thinking of him (e.g. by a hug or symbol transfer), it should be easy to connect to this person via a different communication medium. For instance, holding the phone close to the pillow may automatically contact the remote beloved one by telephone, or holding the pillow close to a display may result in the initiation of a videoconferencing session. This can be realized by integrating NFC (Near Field Communication) technology (antenna and tag) in both the communication device and the pillow. NFC is already being integrated in some mobile telephones. Another possible way of communication is through the Internet via a wireless connection (e.g., Bluetooth™) between the pillow and a local Internet access device, which may be incorporated in the pillow or be provided as a separate unit, such as a PC, PDA, cell phone, or a similar communication device.

Additional Options

In a more advanced embodiment of the hug mode, both pillows would be able to “sense” the heart rate (a corresponding heart rate measuring device may be provided inside or outside the pillow), and possibly other parameters indicating emotions or “state of mind” of its owner when hugged, and to communicate them to the other pillow. For instance, the remote pillow could communicate the person's “state of mind” by means of colors, or light pulsations.

A device for determining an emotion related condition of a person and providing feedback about this condition may be implemented to provide the aforesaid “sense” capabilities, for example, as disclosed in patent application Serial No. EP 05 100 832.4, filed Feb. 7, 2005, (Attorney Docket No. NL 050143), entitled “Device for Determining an Emotion Related Condition of a Person and Providing Feedback about this Condition.” In reference to this technology, the device comprises at least one body sensor for detecting an emotion related body parameter, an emotion assessing element, and a feedback device, wherein the emotion assessing element is designed for processing input provided by the body sensor and for determining control parameters for controlling the feedback device, on the basis of the input provided by the body sensor, and wherein the body sensor is integrated in a textile structure. As a result of the fact that body sensors are incorporated in a textile structure, it is possible to gather parameters representing the stress state of an examined person in an unobtrusive and pleasant way. The emotion assessing element and the feedback device may be incorporated in the textile structure as well. Application of the device may even lead to an enhancement of the state of relaxation, given the fact that contact to a textile may generate a feeling of comfort. This can be an efficient and useful addition to the pillow according to the present invention.

Although pillows have been described, any shape of object having tactile fabric sensor array or the like may be used. For example, instead of a pillow, a teddy bear or some other object may be configured similar to the pillow.

Finally, the above-discussion is intended to be merely illustrative of the present invention and should not be construed as limiting the appended claims to any particular embodiment or group of embodiments. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function; and
e) each of the disclosed elements may be comprised of hardware portions (e.g., discrete electronic circuitry), software portions (e.g., computer programming), or any combination thereof.

1. A communication device comprising:
a tactile sensor configured to receive tactile input including one of a traced shape, a predefined shape and a constricting pressure;
a controller configured to categorize said tactile input in accordance with presets, and
output a transmit signal including a characterization of said tactile input in accordance with said presets; and
a renderer configured to provide an illuminating pattern associated with said characterization.

2. The communication device of claim 1, wherein said illuminating pattern includes at least one of a contour of said traced shape and a figure representing said traced shape selected from said presets.

3. The communication device of claim 1, wherein said renderer is remote from said communication device.

4. The communication device of claim 1, further comprising a first textile covered object and said renderer is part of a second textile covered object being remote from said first textile covered object.

5. The communication device of claim 1, wherein said renderer includes an array of light sources configured to provide said illuminating pattern in varying intensity, color or frequency.

6. The communication device of claim 1, wherein said controller is configured to vary at least one of intensity, color or frequency of an array of light sources of said renderer to be indicative of a type of said tactile input.

7. The communication device of claim 1, wherein said traced shape is at least one of a symbol, a word and a drawing.

8. The communication device of claim 1, wherein said characterization includes at least one of a hug, a symbol, a word and a drawing

9. The communication device of claim 1, wherein said presets include said predefined shape selected in response to providing pressure to at least one of a predetermined area of said tactile sensor and a selection button.

10. The communication device of claim 1, wherein said tactile sensor includes at least one of a predetermined area and a button configured to transmit said transmit signal to activate a renderering device remote from said renderer.

11. The communication device of claim 10, wherein at least one of said renderering device and said renderer is at least one of a pillow and a textile covered object.

12. The communication device of claim 10, wherein said renderering device provides a message that said renderer had transmitted said transmit signal when an acknowledgement is not received by at least one of a user of said renderering device and said renderer in response to said transmit signal.

13. The communication device of claim 1, wherein said controller is configured to transmit said transmit signal in response to a gesture, said gesture including at least one of holding said tactile sensor near a tagged object.

14. The communication device of claim 1, wherein said controller is configured to activate a communication link for communication with a person associated with said tagged object.

15. The communication device of claim 1, wherein said tagged object includes an item associated with a person to be communicated with.

16. The communication device of claim 1, wherein said tagged object is included in a picture frame including a person to be communicated with.

17. The communication device of claim 1, wherein said controller is configured to communicate with a selected person through a communication link, said communication link being a telephone communication link when a telephone and said renderer are in proximity of each other, and said communication link being a videoconferencing link when a display and said renderer are in proximity of each other.
